(19) United States
(12) Patent Application Publication
(10) Pub. No.: US 2026/0030433 A1
(43) Pub. Date: Jan. 29, 2026

(54) ENHANCED AUTOMATIC EVALUATION OF HIERARCHICAL DOCUMENTS

(71) Applicant: INTUIT INC., Mountain View, CA (US)

(72) Inventors: Siddharth JAIN, Mountain View, CA (US); Sivashanker THIRUCHITTAMPALAM, Toronto (CA); Jonathan LIN, Ontario (CA); Venkat Narayan VEDAM, Mountain View, CA (US)

(21) Appl. No.: 18/781,591

(22) Filed: Jul. 23, 2024

(51) Int. Cl. G06F 40/137; G06F 40/166

(52) U.S. Cl. CPC G06F 40/137; G06F 40/166

(57) ABSTRACT

Aspects of the present disclosure relate to automated evaluation of hierarchical documents. Embodiments include generating a canonical representation of each hierarchical path within a document; assigning weights to each hierarchical path within the document based on the canonical representation of the hierarchical path; calculating a first score for each hierarchical path within the document based on: a corresponding weight for the hierarchical path; and identifying one or more errors within the hierarchical path based on the canonical representation of the hierarchical path; calculating a second score for each hierarchical path within the document based on: the corresponding weight for the hierarchical path; and determining whether a value within the canonical representation of the hierarchical path complies with a rule; and calculating a composite score for the document based on the first score and the second score for each hierarchical path within the document.

### INTRODUCTION

Aspects of the present disclosure relate to techniques for automatically evaluating hierarchical documents such as computer code, databases, and/or the like. In particular, techniques described herein involve creating a canonical representation of a hierarchical document, assigning weights to each hierarchical path within the canonical representation, and then evaluating the document based on the weighted hierarchical paths.

### BACKGROUND

Every year, millions of people, businesses, and organizations around the world utilize hierarchical documents. For example, a hierarchical document may be software code used to implement an application. The hierarchy of such code may include nests, lines of code within a function, subfields within a field, and/or the like.

Hierarchical documents may require thorough editing to prevent errors and ensure proper function. For example, a programmer may neglect to complete a hierarchical path within an item of code, automatically generated code may contain an incorrect value for a field, and/or the like. Detecting such errors through manual evaluation may be impractical due to the size of documents such as software code. As an example, evaluating code for a software application may involve painstakingly checking thousands of lines of code.

Attempts to automate the evaluation of documents have met with various technical challenges. For instance, existing automated techniques for evaluating documents fail to account for the hierarchical structure of such documents. Thus, while a machine learning model trained to evaluate documents based on comparing the documents to a ground-truth optimal document may be able to identify textual errors in a document, such a machine learning model may fail to identify structural errors in such documents. Also, such a machine learning model may fail to evaluate the document based on the importance of different elements within the document (e.g., some errors may impact performance more than others). Additionally, a machine learning model that evaluates documents by comparing the documents to an optimal document may fail to adapt to the needs of specific users.

Thus, there is a need in the art for improved techniques for automated evaluation of hierarchical documents.

### BRIEF SUMMARY

Certain embodiments provide an automated method for evaluating hierarchical documents. The method generally includes: generating a canonical representation of each hierarchical path within a document; assigning weights to each hierarchical path within the document based on the canonical representation of the hierarchical path; calculating a first score for each hierarchical path within the document based on: a corresponding weight for the hierarchical path; and identifying one or more errors within the hierarchical path based on the canonical representation of the hierarchical path; calculating a second score for each hierarchical path within the document based on: the corresponding weight for the hierarchical path; and determining whether a value within the canonical representation of the hierarchical path complies with a rule; and calculating a composite score for the document based on the first score and the second score for each hierarchical path within the document.

Other embodiments provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to automated evaluation of hierarchical documents.

FIG. 2 depicts an additional example of computing components related to automated evaluation of hierarchical documents.

FIG. 3 depicts an example of a hierarchical document represented as a data tree.

FIG. 4 depicts an example of a hierarchical document and a canonical representation of the hierarchical document.

FIG. 5 depicts an example of operations related to automated evaluation of hierarchical documents

FIG. 6 depicts an example of a processing system for automated evaluation of hierarchical documents.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automatically evaluating hierarchical documents.

According to certain embodiments, hierarchical paths within a document are decomposed into canonical representations (e.g., a listing of the field names within a path). These canonical representations are then given weights based on the importance of the path (e.g., using a machine learning model trained to weigh paths based on canonical representations). Two scores may be calculated for each of the canonical paths based on the weight for the path. A first score may be based on errors found within the hierarchical path (e.g., the path does not contain all required fields or have a value in a field). A second score may be based on determining whether a value within the path complies with a rule (e.g., a rule that indicates a format or range for a value in a field). A composite score may be calculated for the document based on the scores for the paths. The composite score may be used as an evaluation metric for the quality of the document. For example, the composite score may be used as labeling data for a supervised learning process to train or re-train a machine learning model (e.g., a model that generated the scored document).

In some embodiments, a hierarchical document comprises one or more hierarchical paths. For instance, a hierarchical document may be represented as a data tree and each branch within the data tree may represent a hierarchical path. A hierarchical path may begin with a field. Different paths may include different subfields within the field. For example, a nested software function may contain multiple hierarchical paths. The “beginning” or “top” of a hierarchical path within the function may be a field corresponding to a name for the function. The function may contain one or more subfunctions or other lines of code. A hierarchical path may terminate at the end of a line of code that does not have another line of code nested underneath (e.g., at the end of a subfunction within the function). As another example, the document may be a database. The hierarchical path may begin at an index and end at an entry in the database. When a hierarchical document is represented as a data tree, a hierarchical path may comprise a parent node, a first child node, and a child node of the first child node. The hierarchical path may begin with the parent node and terminate with the child node of the first child node.

Certain embodiments provide that a canonical representation of each hierarchical path within a document may be generated. A canonical representation may be a list of the fields within a hierarchical path. For example, a hierarchical path within a hierarchical software code may contain the function “FunctionA.” FunctionA may contain the object “ObjectB.” ObjectB may contain the data “DataC.” ObjectB may be nested within FunctionA, and DataC may be nested within ObjectB. The software code may be represented as a data tree such that FunctionA is a parent node to child node ObjectB, and ObjectB is a parent node to child node DataC. In this example, the canonical representation of the hierarchical path for DataC may be FunctionA.ObjectB.DataC. If ObjectB also contains additional data known as “DataD,” the hierarchical path for DataD may be FunctionA.ObjectB.DataD. The canonical representation may be generated by parsing the hierarchical document. In some embodiments, the parsing may be performed by a machine learning model that is trained to extract components of a hierarchical path.

According to some embodiments, the canonical representations may be used to assign weights to each hierarchical path within the document. The weights may be assigned based on the importance of the hierarchical path to the document. For example, an error in a first hierarchical path may cause a significant impact on the performance of the document, while an error in a second hierarchical path may cause only a moderate impact on the performance of the document. In this example, the first hierarchical path may be assigned a higher weight than the second hierarchical path. The weights may be assigned using a machine learning model that is trained (e.g., using a supervised learning process) to assign weights based on canonical representations. For example, the training for the machine learning model may comprise comparing weights assigned to canonical representations by the machine learning model to ground truth weights associated with the canonical representations and adjusting parameters of the machine learning model based on a variance between the assigned weights and the ground truth labels (e.g., ground truth weights).

Some embodiments provide that a first score may be calculated for the hierarchical paths. The first score may by calculated based on identifying errors within a hierarchical path based on the canonical representation of the hierarchical path. The errors identified for calculating the first score generally relate to structural errors, such as the absence of expected fields and/or values from a hierarchical path (e.g., the completeness of the path). For example, a hierarchical path may contain a particular type of field and a correct hierarchical path that contains this field may also contain a second type of field. If the hierarchical path does not include the second type of field, this may be identified as an error. Each identified error may decrease the score for the hierarchical path and/or the document (e.g., by an amount that is based on the weight assigned to the path). For example, if the path has a relatively higher weight, the score for the path and/or the document may be decreased by a relatively large amount. By contrast, if the path has a relatively lower weight, the score for the path and/or the document may be decreased by a relatively small amount (e.g., relative to the large amount). Some embodiments provide that the errors are identified by a machine learning model that is trained to identify errors in hierarchical paths (e.g., such as through a supervised learning process involving training data comprising hierarchical paths with labeled errors).

Certain embodiments provide that a second score may be calculated for the hierarchical paths. The second score may by calculated based on determining whether a value within the canonical representation of the hierarchical path complies with a rule. The rule may be provided by a user of a document evaluation system. For example, a rule may specify a correct format for a value within a field, an allowed range for a value within a field, and/or the like. Calculating a score based on custom rules provided by users may allow for a greater level of customization for a document evaluation system. For example, the first score may be based on structural requirements for items within a document such as functions and objects; these requirements may be consistent across users and domains. Thus, the first score may be calculated based on training data gathered from multiple users and domains. The second score, however, may be based on a custom rule that is specific to the requirements of a particular user and/or domain (for example, a range for data values required for a particular user's application). In other words, training data involving the rule may not exist. The second score for the hierarchical path and/or document may be decreased if an item within a hierarchical path contains a value that does not comply with a rule. The amount by which the score for the hierarchical path and/or the document is decreased may be based on the weight assigned to the path. For example, if the path has a relatively higher weight, the score for the path and/or the document may be decreased by a relatively large amount. By contrast, if the path has a relatively lower weight, the score for the path and/or the document may be decreased by a relatively small amount (e.g., relative to the large amount).

Some embodiments provide that the scoring may be based on selecting a rule for a given hierarchical path. For example, a path may contain a particular type of field. Based on the presence of this field within the path, a rule associated with the field may be selected for scoring the path.

In some embodiments, a composite score may be calculated for the document based on the first and second scores. For example, the composite score may be a sum of the first and second scores or a weighted combination of the first and second scores. The composite score may be generated based on assigning weights to the first and second scores. For example, structural correctness may be more important for a given document than compliance with the rules used to calculate the second score. In such instances, the first scores may be assigned a higher weight than the second scores. The second scores may be assigned a higher weight than the first scores in instances where compliance with one or more rules is more important than structural correctness. The weights for the first and second scores may be assigned based on an indication from a user regarding the importance of the first and second scores (e.g., the weights may be selected by the user or assigned based on an answer provided to a question regarding the importance of structural correctness compared to rule compliance). In certain embodiments, the weights may be assigned automatically, such as by using a machine learning model trained to assign weights to first and second scores.

According to certain embodiments, the composite score may be represented as a normalized number, a percentage, and/or the like. The composite score may be used as an evaluation metric for a document. For example, the score represents a document's compliance with structural requirements and user-specific rules (based on the importance of each) and may provide an indication regarding the performance of the document. The composite score may be used in various generative machine learning applications. For example, the evaluated documents may be generated by a machine learning model. If a document has a low composite score, this may indicate that a prompt provided to the machine learning model should be modified, and the prompt may be modified accordingly. As another example, the composite score may be used as a label for training data for a supervised learning process involving a machine learning model (e.g., the composite score may be used as a ground-truth indication of the quality of a generated document).

Embodiments of the present disclosure provide numerous technical and practical effects and benefits. Generating canonical representations of documents allows for automated evaluation of documents that can detect structural errors in the documents. For example, when presented with a canonical representation of a document, a machine learning model may be able to identify errors (e.g., a missing field within a hierarchical path) that would otherwise be overlooked if the model were provided with the document in its original format or another, non-canonical format. The canonical representations also allow a machine learning model to generate weights for hierarchical paths based on a level of importance for each path. As an example, a machine learning model may be unable to identify paths and assign weights to paths unless provided with canonical representations of the paths. The weighted canonical representations allow for greater accuracy in evaluating documents because the evaluation will be based on the importance of the different hierarchical paths. Furthermore, techniques disclosed herein allow for an evaluation metric that combines the effectiveness of machine learning techniques for assessing the structural correctness of documents with the flexibility of user-provided rules. Thus, the evaluation may be tailored to particular use cases while maintaining a level of accuracy that is learned across users and domains.

### Example of Computing Components Related to Automated Evaluation of Hierarchical Documents

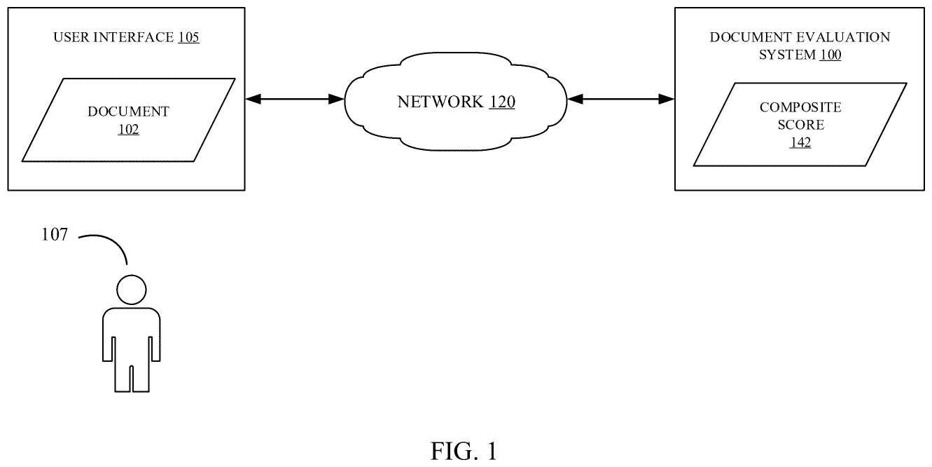

FIG. 1 is an illustration of example computing components related to automatic evaluation of hierarchical documents.

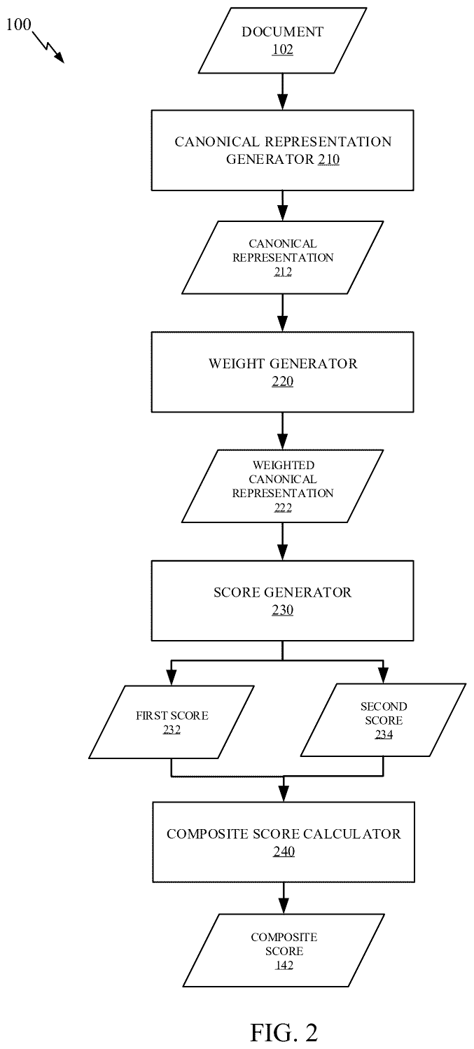

A user 107 of a software application may use a user interface 105 associated with the software application to submit a document 102. The document 102 may be sent to a document evaluation system 100, over a network 120. As described in further detail below with respect to FIG. 2, document evaluation system 100 may generate a composite score 142 for the document 102, which may serve as an indicator of the quality of the document 102. The composite score 142 may be provided to the user interface 105 via the network 120, where it may be presented to the user 107.

FIG. 2 depicts an additional example of computing components related to automatic evaluation of hierarchical documents. In particular, FIG. 2 depicts document evaluation system 100 of FIG. 1 in greater detail.

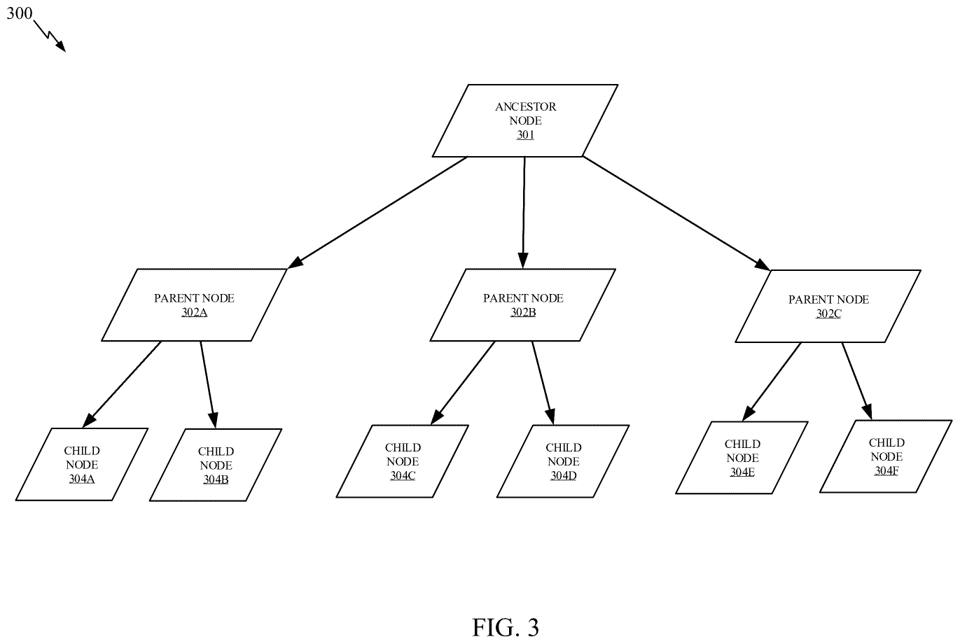

A document 102 may be provided to a document evaluation system 100. The document 102 may be a hierarchical document. As discussed in further detail below with respect to FIG. 3, hierarchical documents include one or more hierarchical paths, which may be represented as nodes within a data tree. A hierarchical path for a child node may begin with the parent node and end with the child node. For example, a hierarchical path may comprise a field (parent node) and a subfield (child node) or a function (parent node) and an object within the function (child node).

The document 102 may be provided to a canonical representation generator 210. The canonical representation generator 210 may be executed via one or more processors and may be configured to parse the document to extract nodes and generate a canonical representation 212 of the document 102 based on the extracted nodes. A canonical representation 212 may comprise a list of nodes or fields (e.g., for a hierarchical path consisting of a field and a subfield, the canonical representation may be field.subfield or subfield.field). In some embodiments, the canonical representation generator 210 may comprise a machine learning model that is trained to parse documents and create canonical representations of the documents. Other techniques for parsing documents as known in the art may be used for generating canonical representations.

The canonical representation 212 may be provided to a weight generator 220 that assigns weights to canonical representations of hierarchical paths within documents. The weight generator 220 may comprise a machine learning model (e.g., a large language model, or LLM) that is trained to assign weights to canonical representations based on the importance of a hierarchical path represented by the canonical representation. For example, if an error in a hierarchical path is likely to severely impact the performance/quality of a document, a canonical representation of the path may be assigned a high weight. By contrast, if an error in a hierarchical path is likely to only moderately impact the performance/quality of a document, a canonical representation of the path may be assigned a lower weight. The weight generator 220 may comprise a machine learning model (e.g., an LLM) that is trained (e.g., through a supervised learning process) to assign weights to canonical representations based on the importance of a hierarchical path represented by the canonical representation. Supervised learning techniques generally involve providing training inputs to a machine learning model. The machine learning model processes the training inputs and outputs predictions based on the training inputs. The predictions are compared to the known labels associated with the training inputs to determine the accuracy of the machine learning model, and parameters of the machine learning model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the predictions produced by the machine learning model based on the training inputs match the known labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and/or the like. In some embodiments, validation and testing are also performed for a machine learning model, such as based on validation data and test data, as is known in the art.

The supervised learning process for a machine learning model used by weight generator 220 may involve canonical representations that have been assigned ground-truth weights (e.g., weights assigned manually by an expert based on the importance of the hierarchical path represented by the canonical representation). The labeled canonical representations may be provided to the machine learning model and parameters of the machine learning model may be iteratively adjusted based on comparing weights output by the model to a weight indicated by the label (e.g., until a weight output by the model matches the weight indicated by the label or until some other condition occurs, such as related to evaluation of a cost function).

The weighted canonical representation 222 may be provided to a score generator 230. The score generator 230 may be executed via one or more processors and may be configured to calculate scores for each hierarchical path based on the weighted canonical representations 222. A first score 232 for the hierarchical path may be calculated based on errors identified within the hierarchical path. The errors identified for calculating the first score 232 generally relate to structural errors, such as the absence of expected fields and/or values from a hierarchical path (e.g., the completeness of the path). For example, a hierarchical path may contain a particular type of field. A correct hierarchical path that contains this field may also contain a second type of field. If the hierarchical path does not include the second type of field, this may be identified as an error. Each identified error may decrease the first score 232 for the hierarchical path. The first score 232 may also be based on the weight assigned to the weighted canonical representation 222. For example, if a given hierarchical path contains an error and also has a high weight, the first score 232 for the given hierarchical path may decrease the composite score 142 for the document 102 by a large amount. If a different hierarchical path contains an error but has a lower weight, the first score 232 for this hierarchical path may decrease the composite score 142 for the document 102 by a smaller amount. Some embodiments provide that the errors are identified by a machine learning model that is trained to identify errors in hierarchical paths (e.g., such as through a supervised learning process involving training data comprising hierarchical paths with labeled errors).

A second score 234 for the hierarchical path may be calculated based on errors identified within the hierarchical path. The second score 234 may by calculated based on determining whether a value within the canonical representation of the hierarchical path complies with a rule. The rule may be provided by a user of the document evaluation system 100. For example, a rule may specify a correct format for a value within a field, an allowed range for a value within a field, and/or the like. As another example, the rule may specify a list of values for the field, and if the value is not one of the specified values, the rule may be violated. The rule may be selected and used to evaluate the document 102 based on detecting a field that is related to the rule (e.g., a rule that applies to the particular type of field). The second score 234 may be decreased if a rule is violated (e.g., if a field contains a value that does not comply with the rule). The second score 234 may also be based on the weight assigned to the weighted canonical representation 222. For example, if a given hierarchical path contains a rule violation and also has a high weight, the second score 234 for the given hierarchical path may decrease the composite score 142 for the document 102 by a large amount. If a different hierarchical path contains a rule violation but has a lower weight, the second score 234 for this hierarchical path may decrease the composite score 142 for the document 102 by a smaller amount.

The composite score calculator 240 may be executed via one or more processors and may generate a composite score 142 for the document 102. The composite score 142 may be based on the first score 232 and second score 234 for each hierarchical path. As an example, the composite score 142 may be calculated based on summing the first scores and/or second scores for the document 102. The composite score 142 may be calculated based on combining the sums of the first scores and the second scores. For example, the first scores and second scores may be combined, and the composite score may be calculated based on comparing the total score to the possible total score. Thus, paths with higher weights will have a higher impact on the composite score 142.

Calculating the composite score 142 may be further based on assigning additional weights to the first and second scores. For example, structural correctness may be more important for a given document than compliance with the rules that were used to calculate the second scores. In such instances, the first scores may be assigned a higher weight than the second scores. The second scores may be assigned a higher weight than the first scores in instances where compliance with one or more rules is more important than structural correctness. The weights for the first and second scores may be assigned based on an indication from a user regarding the importance of the first and second scores (e.g., the weights may be selected by the user or assigned based on an answer provided to a question regarding the importance of structural correctness compared to rule compliance). In certain embodiments, the weights may be assigned automatically, such as by using a machine learning model trained to assign weights to first and second scores.

The composite score 142 may be represented as a normalized number, a percentage, and/or the like. The composite score 142 may be used as an evaluation metric for the document 102. The composite score 142 represents a document's compliance with structural requirements and user-specific rules (based on the importance of each) and may provide an indication regarding the performance of the document 102. For example, a low composite score 142 may indicate that the document 102 performs poorly or is ill-suited for a user's goals, whereas a high composite score 142 may indicate that the document 102 performs well (e.g., computer code that receives a high score may function as intended). The composite score 142 may be used in various generative machine learning applications. For example, the evaluated documents may be generated by a machine learning model. If a document has a low composite score (e.g., below a threshold), this may indicate that a prompt provided to the machine learning model should be modified, and the prompt may be modified based on such a low composite score. As another example, the composite score may be used as a label for training data for a supervised learning process involving a machine learning model (e.g., the composite score may be used as a ground-truth indication of the quality of a generated document).

### Example of a Hierarchical Document Represented as a Data Tree

FIG. 3 depicts an example of a hierarchical document 300 represented as a data tree according to certain embodiments.

The hierarchical document 300 shown in FIG. 3 is represented as a set of nodes. Each node may correspond to a field within the hierarchical document 300. Each branch within the data tree may represent a hierarchical path. For example, the hierarchical path for child node 304A spans from child node 304A to parent node 302A to ancestor node 301.

As an example, ancestor node 301 may be a function within an item of computer code, such as a query schema. Parent node 302A may be an object referenced by the function (e.g., an object defined as part of the query schema). The object may be nested within the function. Child node 304A may be a line of code within the object or nested in the reference to the object (e.g., the line of code may include a field within the object). It is possible for child nodes to be parent nodes to other child nodes and for ancestor nodes to be child nodes to other nodes in longer hierarchical paths (e.g., hierarchical paths that contain more than three generations).

A canonical representation of the hierarchical path for child node 304A may comprise some or all of the contents of a field associated with ancestor node 301 (e.g., a name for the field and/or other contents), some or all of the contents of a field associated with parent node 302A, and some or all of the contents of a field associated with child node 304A (e.g., the contents of each field may be concatenated to form a list). The canonical representation may omit the contents of the other fields, such as fields associated with parent nodes 302B-C and child nodes 304B-F. Omitting fields that are not included in a hierarchical path from the canonical representation may allow for isolating the hierarchical path such that a machine learning model can evaluate the completeness of the hierarchical path and/or determine the importance of the hierarchical path relative to other paths.

### Example of a Hierarchical Document and a Canonical Representation of the Hierarchical Document

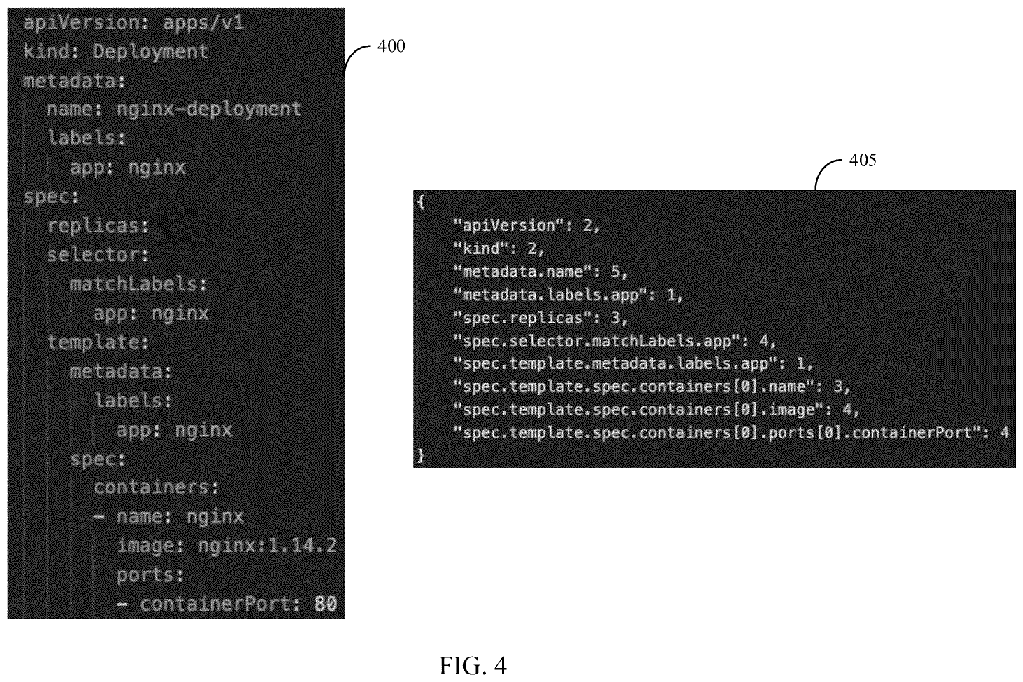

FIG. 4 depicts an example of a hierarchical document 400 and a corresponding canonical representation 405 of the hierarchical document 400.

The hierarchical document 400 shown in FIG. 4 is a Kubernetes specification. The hierarchical document 400 contains the field “metadata.” This field contains the nested subfields “name” and “labels.” The “name” and “labels” subfields are each part of separate hierarchical paths. The subfield “labels” also contains a subfield, “app.” The “app” subfield contains the value “ngix.”

When represented as a data tree as shown above in FIG. 3, the field “metadata” may be represented as an ancestor node to the field “app” (or as a parent node to the “name” and “labels” fields). The field “labels” may be represented as a parent node to the field “app” (or as a child node to the “metadata” field). The field “app” may be represented as a child node to the field “labels.”

The canonical representation for the “app” field's hierarchical path may comprise the “app,” “labels,” and “metadata” fields. For example, the canonical representation may comprise a concatenation of the three fields such as “app.labels.metadata” or “metadata.labels.app”. The canonical representation may follow the hierarchical path in order, either backwards from “app” or forwards to “app.” As shown in 405, the canonical representation of the hierarchical path for the “app” field is “metadata.labels.app”. The canonical representation of this field has been assigned a weight of “1,” indicating a low level of importance. Thus, an error or rule violation in this field may have only a small or moderate impact on the composite score for the hierarchical document 400.

Checking the “app” hierarchical path for completeness may comprise determining whether the “app” field has a value. Here, the “app” field contains the value “nginx,” so it may be determined that the field is complete. A rule for the “app” field may require that the value of the field correspond to the name for an application that can be accessed by the function. If “nginx” is a name for an application that the function can access, then this rule may be satisfied.

### Example Operations Related to Automated Evaluation of Hierarchical Documents

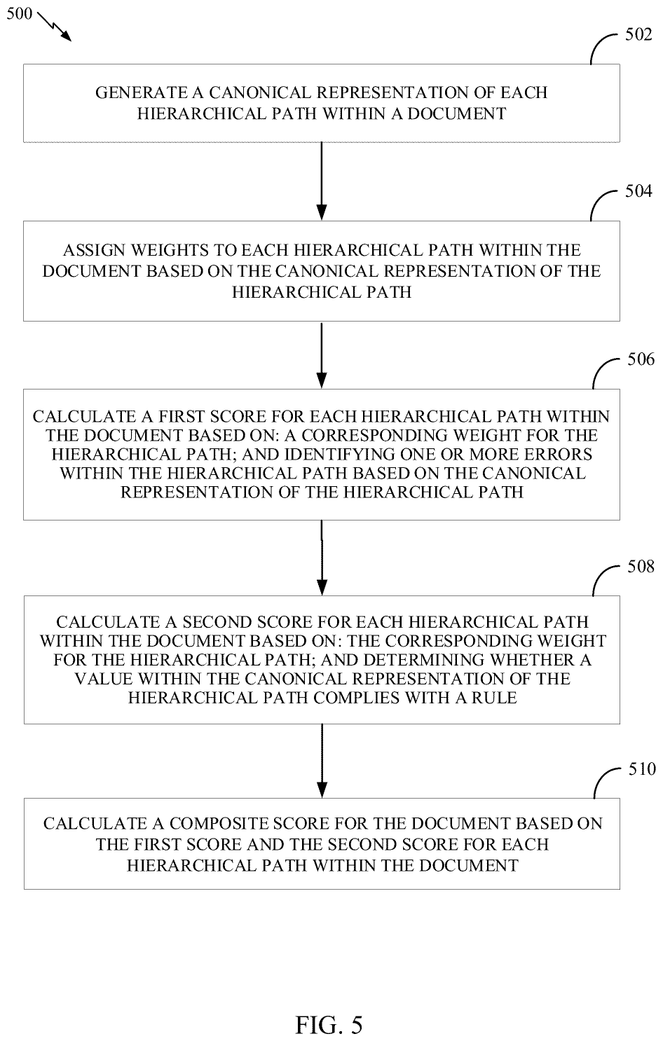

FIG. 5 depicts example operations 500 related to detecting hallucinations in language model outputs. For example, operations 500 may be performed by one or more of the components described with respect to FIG. 1 or FIG. 2.

Operations 500 begin at step 502 with generating a canonical representation of each hierarchical path within a document.

Operations 500 continue at step 504 with assigning weights to each hierarchical path within the document based on the canonical representation of the hierarchical path. In certain embodiments, wherein the weights are assigned by a machine learning model that is trained through a supervised learning process involving training data that comprises hierarchical paths of documents that are assigned weights based on levels of importance of the hierarchical paths.

Operations 500 continue at step 506 with calculating a first score for each hierarchical path within the document based on: a corresponding weight for the hierarchical path; and identifying one or more errors within the hierarchical path based on the canonical representation of the hierarchical path. In some embodiments, the identifying of the one or more errors within the hierarchical path comprises determining whether the hierarchical path is complete.

Operations 500 continue at step 508 with calculating a second score for each hierarchical path within the document based on: the corresponding weight for the hierarchical path; and determining whether a value within the canonical representation of the hierarchical path complies with a rule. According to some embodiments, the rule indicates a format for a value within the hierarchical path. In certain embodiments, the rule indicates a range for a value within the hierarchical path. Some embodiments provide that the rule is selected based on a field within the canonical representation.

Operations 500 continue at step 510 with calculating a composite score for the document based on the first score and the second score for each hierarchical path within the document. According to certain embodiments, the composite score is used to tune a prompt that is used to generate hierarchical documents. Some embodiments provide that the composite score is used as a label to create training data for training a machine learning model to generate hierarchical documents. In some embodiments, the composite score is generated based on assigning respective weights to the first score and the second score. Certain embodiments provide that the respective weight assigned to the second score is based on a level of importance associated with compliance with the rule.

### Example of a Processing System for Automated Evaluation of Hierarchical Documents

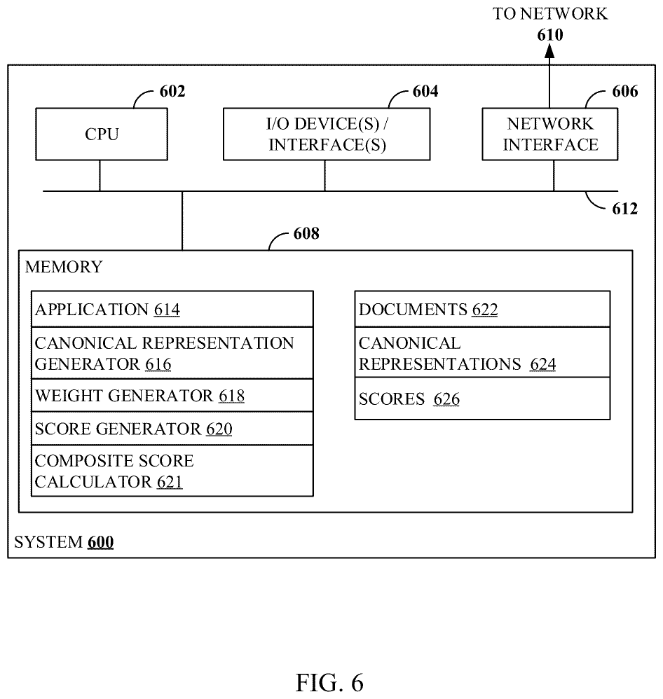

FIG. 6 illustrates an example system 600 with which embodiments of the present disclosure may be implemented. For example, system 600 may be configured to perform operations 500 of FIG. 5 and/or to implement one or more components as in FIG. 1 or FIG. 2.

System 600 includes a central processing unit (CPU) 602, one or more I/O device interfaces that may allow for the connection of various I/O devices 604 (e.g., keyboards, displays, mouse devices, pen input, etc.) to the system 600, network interface 606, a memory 608, and an interconnect 612. It is contemplated that one or more components of system 600 may be located remotely and accessed via a network 610. It is further contemplated that one or more components of system 600 may comprise physical components or virtualized components.

CPU 602 may retrieve and execute programming instructions stored in the memory 608. Similarly, the CPU 602 may retrieve and store application data residing in the memory 608. The interconnect 612 transmits programming instructions and application data, among the CPU 602, I/O device interface 604, network interface 606, and memory 608. CPU 602 is included to be representative of a single CPU, multiple CPUs, a single CPU having multiple processing cores, and other arrangements.

Additionally, the memory 608 is included to be representative of a random access memory or the like. In some embodiments, memory 608 may comprise a disk drive, solid state drive, or a collection of storage devices distributed across multiple storage systems. Although shown as a single unit, the memory 608 may be a combination of fixed and/or removable storage devices, such as fixed disc drives, removable memory cards or optical storage, network attached storage (NAS), or a storage area-network (SAN).

As shown, memory 608 includes application 614, canonical representation generator 616, weight generator 618, score generator 620, and composite score calculator 621. Application 614 may be representative of an application associated with user interface 105 of FIG. 1. In some embodiments, canonical representation generator 616 may be representative of canonical representation generator 210 of FIG. 2. Weight generator 618 may be representative of weight generator 220 of FIG. 2. Score generator 620 may be representative of score generator 230 of FIG. 2. Composite score calculator 621 may be representative of composite score calculator 240 of FIG. 2.

Memory 608 further comprises documents 622, which may correspond to document 102 of FIG. 1 and FIG. 2. Memory 608 further comprises canonical representations 624 which may correspond to canonical representation 212 or weighted canonical representation 222 of FIG. 2. Memory 608 further comprises scores 626, which may include first score 232 and second score 234 of FIG. 1 and composite score 142 of FIG. 1 and FIG. 2.

It is noted that in some embodiments, system 600 may interact with one or more external components, such as via network 610, in order to retrieve data and/or perform operations.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for evaluating hierarchical documents, comprising:
generating a canonical representation of each hierarchical path within a document;
assigning weights to each hierarchical path within the document based on the canonical representation of the hierarchical path;
calculating a first score for each hierarchical path within the document based on:
a corresponding weight for the hierarchical path; and
identifying one or more errors within the hierarchical path based on the canonical representation of the hierarchical path;
calculating a second score for each hierarchical path within the document based on:
the corresponding weight for the hierarchical path; and
determining whether a value within the canonical representation of the hierarchical path complies with a rule; and
calculating a composite score for the document based on the first score and the second score for each hierarchical path within the document.

2. The method of claim 1, wherein the weights are assigned by a machine learning model that is trained through a supervised learning process involving training data that comprises hierarchical paths of documents that are assigned weights based on levels of importance of the hierarchical paths.

3. The method of claim 1, further comprising using the composite score to tune a prompt that is used to generate hierarchical documents.

4. The method of claim 1, further comprising using the composite score as a label to create training data for training a machine learning model to generate hierarchical documents.

5. The method of claim 1, wherein the composite score is generated based on assigning respective weights to the first score and the second score.

6. The method of claim 5, wherein the respective weight assigned to the second score is based on a level of importance associated with compliance with the rule.

7. The method of claim 1, wherein the rule indicates a format for a value within the hierarchical path.

8. The method of claim 1, wherein the rule indicates a range for a value within the hierarchical path.

9. The method of claim 1, wherein the rule is selected based on a field within the canonical representation.

10. The method of claim 1, wherein the identifying of the one or more errors within the hierarchical path comprises determining whether the hierarchical path is complete.

11. A system for evaluating hierarchical documents, comprising:
one or more processors; and
a memory comprising instructions that, when executed by the one or more processors, cause the system to:
generate a canonical representation of each hierarchical path within a document;
assign weights to each hierarchical path within the document based on the canonical representation of the hierarchical path;
calculate a first score for each hierarchical path within the document based on:
a corresponding weight for the hierarchical path; and
identifying one or more errors within the hierarchical path based on the canonical representation of the hierarchical path;
calculate a second score for each hierarchical path within the document based on:
the corresponding weight for the hierarchical path; and
determining whether a value within the canonical representation of the hierarchical path complies with a rule; and
calculate a composite score for the document based on the first score and the second score for each hierarchical path within the document.

12. The system of claim 11, wherein the weights are assigned by a machine learning model that is trained through a supervised learning process involving training data that comprises hierarchical paths of documents that are assigned weights based on levels of importance of the hierarchical paths.

13. The system of claim 11, further comprising using the composite score to tune a prompt that is used to generate hierarchical documents.

14. The system of claim 11, further comprising using the composite score as a label to create training data for training a machine learning model to generate hierarchical documents.

15. The system of claim 11, wherein the composite score is generated based on assigning respective weights to the first score and the second score.

16. The system of claim 15, wherein the respective weight assigned to the second score is based on a level of importance associated with compliance with the rule.

17. The system of claim 11, wherein the rule indicates a format for a value within the hierarchical path.

18. The system of claim 11, wherein the rule indicates a range for a value within the hierarchical path.

19. The system of claim 11, wherein the rule is selected based on a field within the canonical representation.

20. The system of claim 11, wherein the identifying of the one or more errors within the hierarchical path comprises determining whether the hierarchical path is complete.
